(19) United States
(12) Patent Application Publication
(10) Pub. No.: US 2009/0052768 A1
(43) Pub. Date: Feb. 26, 2009

(54) IDENTIFYING A SET OF IMAGE CHARACTERISTICS FOR ASSESSING SIMILARITY OF IMAGES

(75) Inventor: Luyin Zhao, White Plains, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/281,421

(22) PCT Filed: Feb. 27, 2007
(86) PCT No.: PCT/IB2007/050621

§ 371 Date: Sep. 2, 2008

Related U.S. Application Data
(60) Provisional application No. 60/778,807, filed on Mar. 3, 2006.

(51) Int. Cl. G06K 9/62

(52) U.S. Cl. 382/159

(57) ABSTRACT

The invention relates to a method (100) of and a system (200) for identifying a set of image characteristics for assessing similarity of images from a pool of image characteristics on the basis of a set of training images. The obtained set of image characteristics is especially useful for identifying images depicting similar objects. Advantageously, the identified set of image characteristics is human-oriented in the sense that it is based on human perception of image similarity thanks to the use of human rating as a reference for the machine rating of similarity of images. The invention further relates to a method of and a system for identifying a reference image from a database of images on the basis of similarity of the reference image to a given image using the set of image characteristics.

This invention relates to a method of identifying a set of image characteristics for assessing similarity of images.

The invention further relates to a system for identifying a set of image characteristics for assessing similarity of images.

The invention further relates to an image acquisition apparatus comprising said system.

The invention further relates to a workstation comprising said system.

The invention further relates to a computer program product comprising instructions for performing said method when the program product is run on a computer.

An implementation of a method of assessing similarity of images is described in U.S. 20040247166. This method identifies images from a database comprising images of lesions with known diagnoses, similar to a lesion present in a given image. However, the image features used by said method are selected by the user, e.g. a radiologist, from a plurality of predetermined lesion features, such as spiculation, shape, margin sharpness, texture, etc., or are predetermined by the method.

An implementation of a method of selecting a set of image features is described in the article “Feature subset selection for improving the performance of false positive reduction in Lung Nodule CAD” by Boroczky L, Zhao L and Lee K P in IEEE Symposium on Computer-based Medical Systems, June 2005, hereinafter referred to as Ref. 1. The article discloses a method of selecting a subset of features for improving performance of a classifier such as a Support Vector Machine (SVM) by reducing the likelihood of detecting a false lung nodule, when said classifier is used for computer-aided detection of lung nodules. The method uses a genetic algorithm to automatically determine an optimal subset of features from a pool of features. The determined optimal subset of features is then used to train the SVM to classify detected structures as true or false nodules. However, this method cannot be used to select image characteristics for identifying images depicting similar objects such as similar lesions, similar nodules, and/or similar blood vessels. Hereinafter the term “image” may be also interpreted as an image data, an image data set, and an image rendered from an image data. The phrases “an image depicting an object”, “an image showing an object”, and similar phrases may be also interpreted as “an image data comprising a data representing an object”, “an image data set comprising a data subset representing an object”, “depicting an object in an image rendered from an image data”. Similarly, the phrase “an object present in an image” and similar phrases may be also interpreted as “an object depicted in an image rendered from an image data”.

It is an object of the invention to provide an improved method of identifying a set of image characteristics for identifying images depicting similar objects.

This object of the invention is achieved in that the method of identifying a set of image characteristics for assessing similarity of images from a pool of image characteristics on the basis of a set of training images, comprises:
a selecting step for selecting a subset of image characteristics from the pool of image characteristics;
an obtaining step for obtaining a test image;
a computing step for computing a machine rating of at least one image from the set of training images on the basis of similarity between the at least one image and the test image using the subset of image characteristics;
a receiving step for receiving a user rating of the at least one image on the basis of similarity between the at least one image and the test image;
an evaluating step for obtaining an evaluation of the subset of image characteristics on the basis of the user rating and the machine rating of the at least one image;
a modifying step for modifying the subset of image characteristics on the basis of the evaluation; and
an accepting step for accepting the subset of image characteristics as the set of image characteristics on the basis of the evaluation, thereby identifying the set of image characteristics.

Image characteristics for the set of image characteristics are selected from a pool of image characteristics comprising, but not limited to, image features such as contrast, brightness, sphericity, dimensions and/or other features of an object of interest depicted in training images from the set of training images. Optionally, the pool of image characteristics comprises patient characteristics such as age, gender, and weight. First, a subset of image characteristics is selected from the pool of image characteristics. The image characteristics may be selected at random or may be determined by the user. Other schemes for selecting image characteristics for the subset of image characteristics are also possible. In order to determine the usefulness of the selected subset of image characteristics for assessing similarity of images, a test image is selected from a set of training images in the obtaining step. In the computing step, values of characteristics from the subset of image characteristics are obtained for the test image and for at least one image from the set of training images. These values are used for computing a machine rating of the at least one image on the basis of similarity of the at least one image to the test image, also referred to as the machine rating of similarity of the at least one image to the test image. The machine rating of similarity of the at least one image to the test image is based on, for example, a distance between the at least one image from the set of training images and the test image. The distance is computed using the values of image characteristics from the subset of image characteristics. The at least one image and the test image are then shown to a user such as a radiologist. The user gives a user rating of the at least one image on the basis of the similarity between the test image and the at least one image. The user rating may be, for example, an integer ranging from 1 to 10, where 1 denotes the highest level of similarity and 10 denotes the lowest level of similarity. The user rating and the machine rating of the at least one image are then used for evaluating the selected subset of image characteristics. The evaluation may involve, for example, computing the absolute difference between the machine rating of the at least one image mapped into the user rating range and the user rating of the at least one image. The evaluation is used for accepting or rejecting the selected subset of image characteristics as the set of image characteristics. If the evaluation indicates that the selected subset of image characteristics is to be rejected, then the selected subset of image characteristics is modified using, for example, genetic algorithm operators such as mutation and crossover. The modified subset of image characteristic is then evaluated as described above. If the evaluation indicates that the selected subset of image characteristics is to be accepted, the subset of image characteristics is accepted as the set of image characteristics and the method terminates. The subset of image characteristics accepted as the identified set of image characteristics may be used to identify images in a database of images with known diagnoses, which are similar to a given image. Advantageously, the identified set of image characteristics is human-oriented in the sense that it is based on human perception of image similarity thanks to the use of human rating of similarity of the at least one image to the test image as a reference for the machine rating of similarity of the at least one image to the test image.

In an implementation of the method according to the invention, modifying the subset of image characteristics is based on a genetic algorithm. Using a genetic algorithm for identifying a set of image characteristics is described in Ref. 1. Using a genetic algorithm for identifying a set of image characteristics ensures that, on average, identifying the set of image characteristics requires relatively fewer modifying steps, thus making the method more efficient.

In an implementation of the method according to the invention, the method further comprises an identifying step for identifying a reference image from a database of images on the basis of similarity of the reference image to a given image using the set of image characteristics. Typically the given image is an undiagnosed image and the database of images comprises diagnosed images. The reference image similar to the given image may be used in CAD systems for computer-aided diagnosis.

In an implementation of the method according to the invention, the method further comprises a presenting step for presenting the given image and the reference image to a user. This offers the user, e.g. a radiologist, an opportunity to visually compare the given image with the reference image, which can be very helpful to the user for making a diagnosis.

It is a further object of the invention to provide a system for identifying a set of image characteristics of the kind described in the opening paragraphs that is useful for identifying images depicting similar objects. This is achieved in that the system for identifying a set of image characteristics for assessing similarity of images from a pool of image characteristics on the basis of a set of training images comprises:

a selecting unit for selecting a subset of image characteristics from the pool of image characteristics;

an obtaining unit for obtaining a test image;

a computing unit for computing a machine rating of at least one image from the set of training images on the basis of similarity between the at least one image and the test image using the subset of image characteristics;

a receiving unit for receiving a user rating of the at least one image on the basis of similarity between the at least one image and the test image;

an evaluating unit for obtaining an evaluation of the subset of image characteristics on the basis of the user rating and the machine rating of the at least one image;

a modifying unit for modifying the subset of image characteristics on the basis of the evaluation; and

an accepting unit for accepting the subset of image characteristics as the set of image characteristics on the basis of the evaluation, thereby identifying the set of image characteristics.

It is a further object of the invention to provide an image acquisition apparatus of the kind described in the opening paragraphs that is useful for identifying images depicting similar objects. This is achieved in that the image acquisition apparatus comprises a system for identifying a set of image characteristics for assessing similarity of images from a pool of image characteristics on the basis of a set of training images, the system comprising:

a selecting unit for selecting a subset of image characteristics from the pool of image characteristics;

an obtaining unit for obtaining a test image;

a computing unit for computing a machine rating of at least one image from the set of training images on the basis of similarity between the at least one image and the test image using the subset of image characteristics;

a receiving unit for receiving a user rating of the at least one image on the basis of similarity between the at least one image and the test image;

an evaluating unit for obtaining an evaluation of the subset of image characteristics on the basis of the user rating and the machine rating of the at least one image;

a modifying unit for modifying the subset of image characteristics on the basis of the evaluation; and

an accepting unit for accepting the subset of image characteristics as the set of image characteristics on the basis of the evaluation, thereby identifying the set of image characteristics.

It is a further object of the invention to provide a workstation of the kind described in the opening paragraphs that is useful for identifying images depicting similar objects. This is achieved in that the workstation comprises a system for identifying a set of image characteristics for assessing similarity of images from a pool of image characteristics on the basis of a set of training images, the system comprising. a selecting unit for selecting a subset of image characteristics from the pool of image characteristics;

an obtaining unit for obtaining a test image;

a computing unit for computing a machine rating of at least one image from the set of training images on the basis of similarity between the at least one image and the test image using the subset of image characteristics;

a receiving unit for receiving a user rating of the at least one image on the basis of similarity between the at least one image and the test image;

an evaluating unit for obtaining an evaluation of the subset of image characteristics on the basis of the user rating and the machine rating of the at least one image;

a modifying unit for modifying the subset of image characteristics on the basis of the evaluation; and

an accepting unit for accepting the subset of image characteristics as the set of image characteristics on the basis of the evaluation, thereby identifying the set of image characteristics.

It is a further object of the invention to provide a computer program product of the kind described in the opening paragraphs that can identify a set of image characteristics useful for identifying images depicting similar objects when said computer program product is run on a computer. This is achieved in that the computer program product, to be loaded by a computer arrangement, comprises instructions for identifying a set of image characteristics for assessing similarity of images from a pool of image characteristics on the basis of a set of training images, the computer arrangement comprising a processing unit and a memory, the computer program product, after being loaded, providing said processing unit with the capability to carry out the following tasks:

selecting a subset of image characteristics from the pool of image characteristics;

obtaining a test image;

computing a machine rating of at least one image from the set of training images on the basis of similarity between the at least one image and the test image using the subset of image characteristics;

receiving a user rating of the at least one image on the basis of similarity between the at least one image and the test image;

obtaining an evaluation of the subset of image characteristics on the basis of the user rating and the machine rating of the at least one image;

modifying the subset of image characteristics on the basis of the evaluation; and

accepting the subset of image characteristics as the set of image characteristics on the basis of the evaluation, thereby identifying the set of image characteristics.

Modifications and variations thereof, of the system, of the image acquisition apparatus, of the workstation, and/or of the computer program product, which correspond to modifications of the method and variations thereof, being described, can be carried out by a skilled person on the basis of the present description.

The method of the present invention can be applied to various multidimensional images, which can be routinely generated nowadays by various data acquisition modalities such as, but not limited to, Magnetic Resonance Imaging (MRI), Computed Tomography (CT), Ultrasound (US), Positron Emission Tomography (PET), Single Photon Emission Computed Tomography (SPECT), and Nuclear Medicine.

These and other aspects of the invention will become apparent from and will be elucidated with respect to the implementations and embodiments described hereinafter and with reference to the accompanying drawings, wherein:

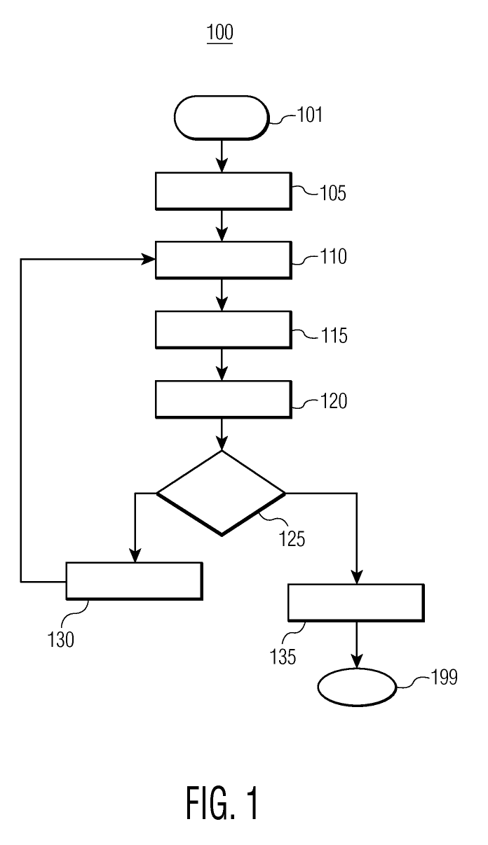

FIG. 1 shows a flowchart of an exemplary implementation of the method;

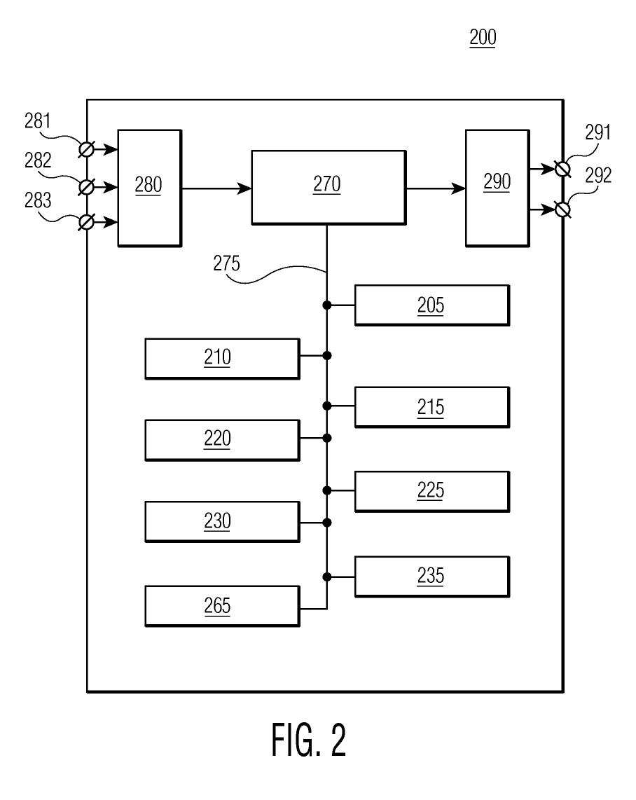

FIG. 2 schematically shows an exemplary embodiment of the system;

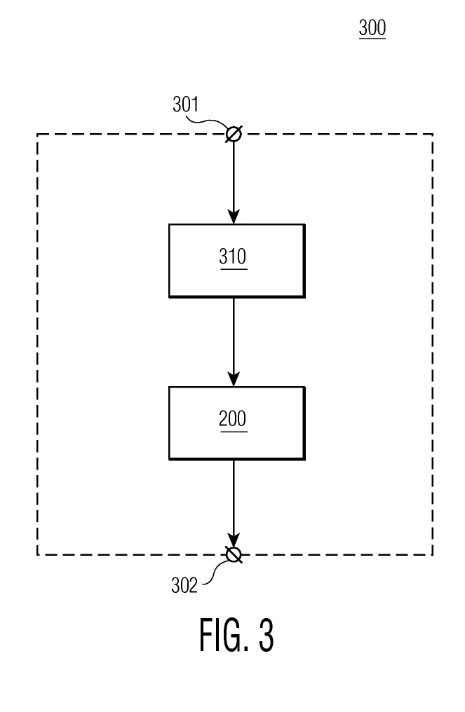

FIG. 3 schematically shows an exemplary embodiment of the image acquisition apparatus; and

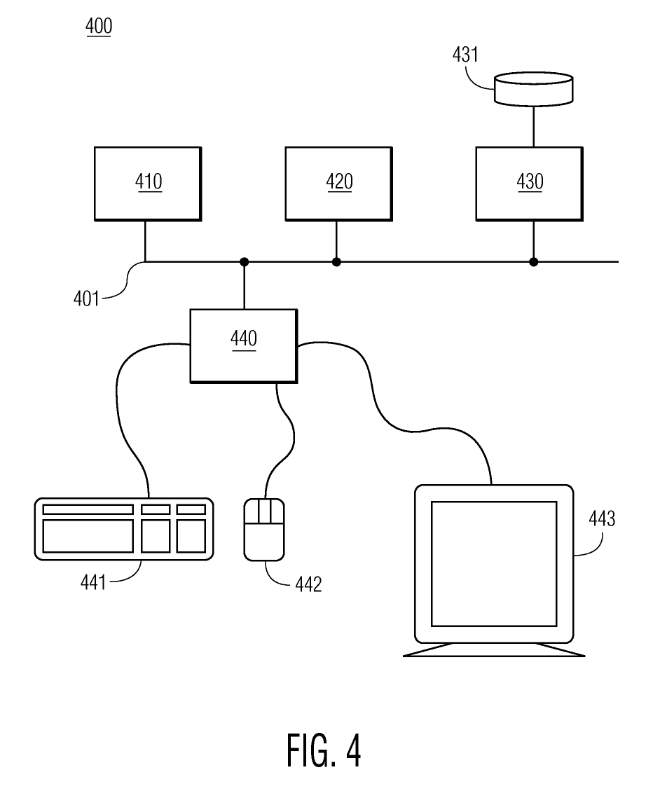

FIG. 4 schematically shows an exemplary embodiment of the workstation.

Same reference numerals are used to denote similar parts throughout the Figures.

FIG. 1 shows a flowchart of an exemplary implementation of the method 100 of identifying a set of image characteristics from a pool of image characteristics. After a starting step 101 the method 100 continues to a selecting step 105 for selecting a subset of image characteristics from a pool of image characteristics as a candidate set of image characteristics. After the selecting step 105, the method 100 continues to an obtaining step 110 for obtaining a test image. The method 100 then continues to a computing step 115 for computing a machine rating of at least one image from the set of training images on the basis of similarity between the at least one image and the test image. The similarity between the at least one image and the test image is computed using the subset of image characteristics. After the computing step 115, the method 100 continues to a receiving step 120, where the test image and the at least one image are presented to a user. The method 100 receives a user rating of similarity between the test image and the identified at least one image. Then the method 100 continues to an evaluating step 125 for evaluating the subset of image characteristics on the basis of the machine rating and the user rating of similarity between the test image and the identified at least one image. If the evaluation indicates that the subset of image characteristics cannot be accepted as the set of image characteristics, the method 100 continues to a modifying step 130 where the subset of image characteristics is modified. After the modifying step 130, the method 100 returns to the obtaining step 110 for obtaining a test image and continues processing the modified subset of image characteristics. If the evaluation indicates that the subset of image characteristics can be accepted as the set of image characteristics, the method 100 continues to an accepting step 135, where the subset of image characteristics is accepted as the identified set of image characteristics. The method 100 then continues to a terminating step 199.

The input to the method 100 comprises a pool of image characteristics and a set of training images. The pool of image characteristics may comprise image features such as contrast, brightness, sphericity and/or dimensions of an object comprised in the image. Optionally, the pool of image characteristics comprises patient characteristics such as age, and weight. A subset of image characteristics is selected from the pool of image characteristics in the selecting step 105. The image characteristics for this subset may be selected by the method 100 or by the user in the selecting step 105. Optionally, the initial subset of image characteristics may be predefined. The size of the subset of image characteristics is predefined and may comprise, for example, 10 image characteristics. Alternatively, the size of the subset of image characteristics may be varying.

In an implementation of the method, the set of training images comprises a plurality of diagnosed 2D x-ray images stored in a database, each image depicting a similar object—a lung nodule—in a plane substantially identical to the plane determined by two eigenvectors of the inertia matrix of the delineated lung nodule, the first eigenvector corresponding to the smallest eigenvalue of the inertia matrix and the second eigenvector corresponding to the largest eigenvalue of the inertia matrix. The pool of image characteristics comprises 2D and 3D image features. The image features comprise, but are not limited to, the volume of the delineated nodule, the maximum, minimum, mean, and standard deviation of grey level inside the delineated nodule, the ratios of eigenvalues of the inertia matrix of the delineated nodule, and the area of the surface of the delineated nodule. Furthermore, the pool of image characteristics comprises patient characteristics comprising, but not limited to, age, weight, blood pressure, and white blood cell count.

Alternatively, the set of training images may comprise 3D image data sets acquired, for example, by an MRI acquisition apparatus. The image data sets may comprise a data subset representing an object such as a lung nodule. In the case of 3D image data sets, depicting an object is to be interpreted as comprising a data subset representing the object and depicting an object in a view rendered from the image data set comprising a data subset representing the object.

In the obtaining step 110, a test image is obtained. Typically, the test image is randomly selected by the method from the set of training images depicting an object of interest. A database storing the training images may also store values of some image characteristics from the pool of image characteristic such as patient age, weight, diagnosis, the size of a lung nodule depicted in the image, etc. These characteristics may be used for selecting the test image. Alternatively, the test image may be selected from another set of images.

In the computing step 115, the values of image characteristics from the subset of image characteristics, selected in the selecting step 105, are obtained for at least one image from the set of training images and the test image. If the values of image characteristics from the subset of image characteristics are stored in a database, these stored values are retrieved. Otherwise the values of image characteristics from the subset of image characteristics are computed. Typically, the values of image characteristics from the subset of image characteristics are obtained for a plurality of training images from the set of training images. Often, the plurality of training images comprises all images from the set of training images. Alternatively, the plurality of training images may be determined by the method or by the user. The values of the image characteristics from the subset of image characteristics are used to compute machine ratings of images from the plurality of training images on the basis of similarity between the test image and the respective images from the plurality of training images. A machine rating R(t,i) of an image i from the plurality of training images is the Mahalanobis distance, based on image characteristics comprised in the subset of image characteristics, between the test image t and the image i, defined by

$$R ( t , i ) = \sqrt{{\sum }_{p , q ∈ P} ( p ( t ) - p ( i ) ) ( q ( t ) - q ( i ) ) {( {C}^{- 1} )}_{pq}} ,$$

where p and q are image characteristics from the subset P of image characteristics selected in the selecting step 105, p(t) and q(t) are values of characteristics p and q for the test image t, p(i) and q(i) are values of characteristics p and q for the image i, and (C⁻¹)_{pq} are matrix elements of the inverse of the covariance matrix C. The Mahalonobis distance is described in the article “Mahalanobis distance” available at http://en.wikipedia.org/wiki/Mahalanobis_distance. An element C_{pq} of the covariance matrix C is defined by the values p(i) and q(i) of image characteristics p and q as

$${C}_{pq} = \frac{1}{n} {\sum }_{i = 1}^{n} ( p ( i ) - \overline{p} ) ( q ( i ) - \overline{q} ) ,$$

where n is the number of images in the plurality of training images and where

$$\overline{p} = \frac{1}{n} {\sum }_{i = 1}^{n} p ( i ) and \overline{q} = \frac{1}{n} {\sum }_{i = 1}^{n} q ( i ) .$$

Alternatively, n may be the number of images in the set of training images. The covariance matrix is described in the article “Covariance matrix” available at http://en.wikipedia.org/wiki/Covariance_matrix.
Alternatively, the machine rating R(t,i) is the Euclidean distance between the test image t and the image i from the plurality of training images, defined by

$$R ( t , i ) = \sqrt{{\sum }_{p ∈ P} {( p ( t ) - p ( i ) )}^{2}} .$$

Another machine rating may comprise a term based on a histogram of a first region of the image i and on a histogram of a second region of the test image t. The skilled person will understand that there are many functions suitable for defining image similarity and/or the machine rating of an image and that the definitions used in this description are for illustration purposes only and do not limit the scope of the claims.

The computing step 115 may also involve identifying the at least one image on the basis of the computed machine ratings of images from the plurality of training images. A number of images from the plurality of training images with specified machine ratings, typically the images most similar to the test image, are identified as the at least one image. The number of images is specified by the method. Alternatively, the number of images may be specified by the user. Yet another possibility is to specify a condition to be satisfied by the machine rating. In the latter case, all images from the plurality of training images which satisfy the specified condition, are identified as the at least one image.

The at least one image and the test image are presented to the user in the receiving step 120. The user rates the similarity of the test image to the at least one image. The user rating may be, for example, a number ranging from 1 to 10, where 1 denotes the highest level of similarity and 10 denotes the lowest level of similarity, or vice versa. The user rating and a reference to the test image may be stored for future use. Alternatively, a database may comprise a previously acquired user rating of similarity of the test image to the identified at least one image. In the latter case no user interaction is necessary to receive the user rating of the at least one image; the received user rating of the at least one image is retrieved from the database.

The subset of image characteristics selected in the selecting step 105 is evaluated in the evaluating step 125 on the basis of the user rating and the machine rating of similarity of the test image to the at least one image from the set of training images. The evaluation may involve, for example, computing the absolute value of the difference between the machine rating R(t,i) mapped into the range of user ratings and the user rating U(t,i). The absolute value of the differences |M(R(t,i))⁻ U(t,i)|, where M(R(t,i)) denotes the machine rating R(t,i) of the at least one image i mapped by a function M into the range of user ratings, is a term of a sum S. The sum S may comprise similar terms defined for other training images with computed machine ratings and received user ratings. If the evaluation indicates that the selected subset of image characteristics is not acceptable, e.g. if the sum S is greater than a threshold, the method 100 continues to the modifying step 130. If the evaluation indicates that the selected subset of image characteristics is acceptable, the method 100 continues to the accepting step 135 and terminates.

In an implementation of the method 100, the termination of the method occurs when no improvement of the subset of image characteristics defined by the sum S is obtained after a predefined number of modifications of the subset of image characteristics. Optionally, the termination of the method 100 occurs when a predefined number of modifications of the subset of image characteristics are evaluated. All subsets of image characteristics and the results of evaluation of these subsets are stored in a log file. After evaluating the last subset of image characteristics, the best subset of image characteristics is retrieved from the log file and identified as the set of image characteristics.

The skilled person will understand that other evaluation techniques may be also used and that the described technique illustrates rather than limits the invention.

In the modifying step 130, the selected subset of image characteristics is modified by removing one or more characteristics from the subset of image characteristics and/or by adding one or more characteristics from the pool of image characteristics. The modification may be based on any suitable algorithm. For example, the modification may involve randomly replacing one image characteristic in a previously evaluated subset of image characteristics. If the modified subset of image characteristics is better than the previously evaluated subset of image characteristics, e.g. if the value of the sum S described above for the modified subset of image characteristics is lower than the sum for the previously evaluated subset of image characteristics, then the modification is accepted and the modified subset of image characteristics is accepted as the previously evaluated subset of image characteristics. This previously evaluated subset of image characteristics is modified and the modified subset of image characteristics is evaluated in the next iteration of the method. If the modified set of image characteristics is not better than the previously evaluated subset of image characteristics, the modified set of image characteristics is rejected and the previously evaluated subset of image characteristics is again modified and evaluated in the next iteration of the method. The size of the subset of image characteristics may be fixed or may vary within a predefined range. After the modifying step 130, the method returns to the obtaining step 110 and the next iteration of the evaluation of the modified subset of image characteristics continues. If the evaluation indicates that the modified subset of image characteristics can be accepted as the subset of image characteristics, then the subset of image characteristics is accepted as the set of image characteristics in the accepting step 135.

Optionally, an additional condition such as the number of modifications of the subset of image characteristics may be evaluated in the evaluating step 125. If the number of modifications exceeds a predefined maximum, then the currently best subset of image characteristics may be accepted as the set of image characteristics in the accepting step 135 and the method 100 may terminate. Other conditions may also be applied.

In an implementation of the method 100 of the current invention, modifying the subset of image characteristics is based on a genetic algorithm. In this method, a plurality of subsets of image characteristics are selected from the pool of image characteristics. Each subset of image characteristics from the plurality of subsets is evaluated using a test image and at least one image from the set of training images as previously described. The subsets from the plurality of subsets are modified using a genetic algorithm in the modifying step.

An implementation of a genetic algorithm for modifying subsets of image characteristics is described in Ref. 1. Here the subsets of image characteristics from the pool of image characteristics are called chromosomes, and the image characteristics are called genes. Each chromosome from the group of chromosomes comprises a predetermined number of genes, e.g. 10 genes. Alternatively, different chromosomes may comprise different numbers of genes. The chromosomes are evaluated using the machine rating and the user rating of the chromosomes, for example, using the sum S described above. The evaluation result is called chromosome fitness value. The most useful chromosomes, i.e. the chromosomes having a higher fitness value, e.g. the chromosomes with the lowest sums S, are identified. The chromosomes that are more useful than other chromosomes have a higher likelihood to be modified using the crossover and mutation operations, and a new group of chromosomes is created. Each chromosome from the new group of chromosomes is evaluated. This modification-evaluation process continues until a condition for accepting a chromosome as the set of image characteristics is met. An advantage of the described algorithm is that the algorithm allows to identify and retain the useful genes and to identify and discard the less useful genes in the chromosomes. This ensures that, on average, identifying a useful chromosome, i.e. the set of characteristics, requires relatively fewer modifications.

In an implementation of the method 100 according to the invention, the method 100 further comprises an identifying step for identifying a reference image from a database of images on the basis of similarity of the reference image to a given image using the set of image characteristics. Typically, the given image is an undiagnosed image and the database of images comprises diagnosed images. The values of image characteristics from the set of image characteristics are obtained for the given image and for images from the database of images. These values are used for computing machine ratings of images from the database of images on the basis of similarity between the given image and the images from the database of images. The machine ratings of images from the database of images may be defined, for example, as Mahalanobis distances between the given image and the images from the database of images using the values of image characteristics from the set of image characteristics. The machine ratings of images from the database of images are used to identify a reference image from the database of images. For example, the machine ratings are examined as to whether or not these machine ratings satisfy a condition. If a machine rating satisfies the condition, the respective image is deemed similar to the given image and is identified by the method as the reference image.

In an implementation of the method 100 according to the invention, the method 100 further comprises a presenting step for presenting the given image and the reference to a user. This offers the user an opportunity to visually compare the given image to the reference image, which can be helpful to the user, such as a radiologist, for arriving at a diagnosis. Optionally, the user may be presented with other information derived from the given image and/or from the identified reference image, such as an estimate of the likelihood of malignancy of a lung nodule depicted in the given image, a parameter value describing the lung nodule pictured in the given image, and a parameter value describing the lung nodule depicted in the identified image. The parameters may be image characteristics from the set of image characteristics or may be other predefined or user-selected parameters. Optionally, the user may be further presented with an image and/or an image characteristic that satisfies certain criteria, for example, an image and/or an image characteristic that correspond to a benign lung nodule and/or to a malignant lung nodule, in order to have a useful reference.

The order of steps in the described implementations of the method 100 of the current invention is not mandatory; the skilled person may change the order of some steps or perform some steps concurrently using threading models, multi-processor systems or multiple processes without departing from the concept as intended by the present invention. Optionally, two or more steps of the method 100 of the current invention may be combined into one step. Optionally, a step of the method 100 of the current invention may be split into a plurality of steps.

FIG. 2 schematically shows an exemplary embodiment of a system 200 for identifying at least one image from a database of images on the basis of the set of image characteristics obtainable by any of the claimed methods, comprising:

a selecting unit 205 for selecting a subset of image characteristics from the pool of image characteristics;

an obtaining unit 210 for obtaining a test image;

a computing unit 215 for computing a machine rating of at least one image from the set of training images on the basis of similarity between the at least one image and the test image using the subset of image characteristics;

a receiving unit 220 for receiving a user rating of the at least one image on the basis of similarity between the at least one image and the test image;

an evaluating unit 225 for obtaining an evaluation of the subset of image characteristics on the basis of the user rating and the machine rating of the at least one image;

a modifying unit 230 for modifying the subset of image characteristics on the basis of the evaluation;

an accepting unit 235 for accepting the subset of image characteristics as the set of image characteristics on the basis of the evaluation; and

a user interface 265 for communicating with the system 200.

In the embodiment of the system 200 shown in FIG. 2, there are three input connectors 281, 282 and 283 for the incoming data. The first input connector 281 is arranged to receive data incoming from data storage such as a hard disk, a magnetic tape, flash memory, or an optical disk. The second input connector 282 is arranged to receive data incoming from a user input device such as, but not limited to, a mouse or a touch screen. The third input connector 283 is arranged to receive data incoming from a user input device such as a keyboard. The input connectors 281, 282 and 283 are connected to an input control unit 280.

In the embodiment of the system 200 shown in FIG. 2, there are two output connectors 291 and 292 for the outgoing data. The first output connector 291 is arranged to output the data to data storage such as a hard disk, a magnetic tape, flash memory, or an optical disk. The second output connector 292 is arranged to output the data to a display device. The output connectors 291 and 292 receive the respective data via an output control unit 290.

The skilled person will understand that there are many ways to connect input devices to the input connectors 281, 282 and 283 and the output devices to the output connectors 291 and 292 of the system 200. These ways comprise, but are not limited to, a wired and a wireless connection, a digital network such as a Local Area Network (LAN) and a Wide Area Network (WAN), the Internet, a digital telephone network, and an analogue telephone network.

In an embodiment of the system 200 according to the invention, the system 200 comprises a memory unit 270. The system 200 is arranged to receive an input data from external devices via any of the input connectors 281, 282, and 283 and to store the received input data in the memory unit 270. Loading the data into the memory unit 270 allows a quick access to relevant data portions by the units of the system 200. The input data may comprise the pool of image characteristics and the set of training images. The memory unit 270 may be implemented by devices such as a Random Access Memory (RAM) chip, a Read Only Memory (ROM) chip, and/or a hard disk. Preferably, the memory unit 270 comprises a RAM for storing input data and/or output data. The memory unit 270 is also arranged to receive data from and deliver data to the units of the system 200 comprising the selecting unit 205, the obtaining unit 210, the computing unit 215, the identifying unit 220, the receiving unit 220, the evaluating unit 225, the modifying unit 230, the accepting unit 235, and the user interface 265 via a memory bus 275. The memory unit 270 is further arranged to make the data available to external devices via any of the output connectors 291 and 292. Storing the data from the units of the system 200 in the memory unit 270 advantageously improves the performance of the units of the system 200 as well as the rate of transfer of data from the units of the system 200 to external devices. Optionally, a unit of the system 200 may be implemented as a piece of memory comprising a computer readable code and a processing unit. The computer readable code comprised in a piece of memory provides the processing unit with the capability to carry out the tasks assigned to said unit.

Alternatively, the system 200 does not comprise the memory unit 270 and the memory bus 275. The input data used by the system 200 is supplied by at least one external device, such as an external memory or a processor, connected to the units of the system 200. Similarly, the output data produced by the system 200 is supplied to at least one external device, such as an external memory or a processor, connected to the units of the system 200. The units of the system 200 are arranged to receive the data from each other via internal connections or via a data bus.

In a further embodiment of the system 200 according to the invention, the system 200 comprises a user interface 265 for communicating with the system 200. The user interface 265 may comprise a display unit for displaying data to the user and a selection unit for making selections. Combining the system 200 with a user interface 265 allows the user to communicate with the system 200. The user interface 265 may be arranged to display the test image and the at least one image from the set of training images. Optionally, the user interface may comprise a plurality of modes of operation of the system 200 such as an automatic mode in which all parameters of the method 100 assume default values and/or are generated by the method, and an interactive mode in which the user enters certain selectable method parameters, for example the size of the set of image characteristics, the maximum number of modifications of the subset of image characteristics. The skilled person will understand that more functions can be advantageously implemented in the user interface 265 of the system 200.

Alternatively, the system may employ an external input device and/or an external display connected to the system 200 via the input connectors 282 and/or 283 and the output connector 292. The skilled person will also understand that there exist many user interface devices that can be advantageously comprised in the system 200 of the current invention.

The system 200, such as the one shown in FIG. 2, can be implemented as a computer program product and can be stored on any suitable medium such as, for example, RAM, magnetic tape, magnetic disk, or optical disk. This computer program can be loaded into a computer arrangement comprising a processing unit and a memory. The computer program product, after being loaded, provides the processing unit with the capability to carry out the steps of the system 200.

FIG. 3 schematically shows an embodiment of the image acquisition apparatus 300 employing the system 200 for identifying a set of image characteristics, said image acquisition apparatus 300 comprising an image acquisition unit 310 connected via an internal connection with the system 200 for identifying a set of image characteristics, an input connector 301, and an output connector 302. This arrangement advantageously increases the capabilities of the image acquisition apparatus 300 by providing said image acquisition apparatus 300 with advantageous capabilities of the system 200 for identifying a set of image characteristics that are useful for identifying images depicting similar objects. Examples of image acquisition apparatus comprise, but are not limited to, a CT system, an X-ray system, an MRI system, a US system, a PET system, a SPECT system, and a Nuclear Medicine system.

FIG. 4 schematically shows an embodiment of a workstation 400. The workstation comprises a system bus 401. A processor 410, a memory 420, a disk input/output (I/O) adapter 430, and a user interface (UI) 440 are operatively connected to the system bus 401. A disk storage device 431 is operatively coupled to the disk I/O adapter 430. A keyboard 441, a mouse 442, and a display 443 are operatively coupled to the UI 440. The system 200 for identifying a set of image characteristics, implemented as a computer program, is stored in the disk storage device 431. The workstation 400 is arranged to load the program and input data into memory 420 and execute the program on the processor 410. The user can input information to the workstation 400 using the keyboard 441 and/or the mouse 442. The workstation is arranged to output information to the display device 443 and/or to the disk 431. The skilled person will understand that there are numerous other embodiments of the workstation 400 known in the art and that the present embodiment serves the purpose of illustrating the invention and must not be interpreted as limiting the invention to this particular embodiment.

It should be noted that the above-mentioned implementations and embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. The invention can be implemented by means of hardware comprising several distinct elements and by means of a suitable programmed computer. In the system claims enumerating several units, several of these units can be embodied by one and the same item of hardware or software. The usage of the words first, second and third, et cetera does not indicate any ordering. These words are to be interpreted as names.

1. A method (100) of identifying a set of image characteristics for assessing similarity of images from a pool of image characteristics on the basis of a set of training images, the method comprising:
a selecting step (105) for selecting a subset of image characteristics from the pool of image characteristics;
an obtaining step (110) for obtaining a test image;
a computing step (115) for computing a machine rating of at least one image from the set of training images on the basis of similarity between the at least one image and the test image using the subset of image characteristics;
a receiving step (120) for receiving a user rating of the at least one image on the basis of similarity between the at least one image and the test image;
an evaluating step (125) for obtaining an evaluation of the subset of image characteristics on the basis of the user rating and the machine rating of the at least one image;
a modifying step (130) for modifying the subset of image characteristics on the basis of the evaluation; and
an accepting step (135) for accepting the subset of image characteristics as the set of image characteristics on the basis of the evaluation, thereby identifying the set of image characteristics.

2. A method (100) as claimed in claim 1, wherein modifying the subset of image characteristics is based on a genetic algorithm.

3. A method (100) as claimed in claim 1 further comprising an identifying step for identifying a reference image from a database of images on the basis of similarity of the reference image to a given image using the set of image characteristics.

4. A method (100) as claimed in claim 3 further comprising a presenting step for presenting the given image and the reference image to a user.

5. A system (200) for identifying a set of image characteristics for assessing similarity of images from a pool of image characteristics on the basis of a set of training images, the system comprising:
a selecting unit (205) for selecting a subset of image characteristics from the pool of image characteristics;
an obtaining unit (210) for obtaining a test image;
a computing unit (215) for computing a machine rating of at least one image from the set of training images on the basis of similarity between the at least one image and the test image using the subset of image characteristics;
a receiving unit (220) for receiving a user rating of the at least one image on the basis of similarity between the at least one image and the test image;
an evaluating unit (225) for obtaining an evaluation of the subset of image characteristics on the basis of the user rating and the machine rating of the at least one image;
a modifying unit (230) for modifying the subset of image characteristics on the basis of the evaluation; and
an accepting unit (235) for accepting the subset of image characteristics as the set of image characteristics on the basis of the evaluation, thereby identifying the set of image characteristics.

6. An image acquisition apparatus (300) for acquiring a related image data comprising at least one of the systems as claimed in claim 5.

7. A workstation (400) comprising at least one of the systems as claimed in claim 5.

8. A computer program product to be loaded by a computer arrangement, comprising instructions for processing temporally acquired image data, the computer arrangement comprising a processing unit and a memory, the computer program product, after being loaded, providing said processing unit with the capability to carry out the following tasks:
selecting a subset of image characteristics from the pool of image characteristics;
obtaining a test image;
computing a machine rating of at least one image from the set of training images on the basis of similarity between the at least one image and the test image using the subset of image characteristics;
receiving a user rating of the at least one image on the basis of similarity between the at least one image and the test image;
obtaining an evaluation of the subset of image characteristics on the basis of the user rating and the machine rating of the at least one image;
modifying the subset of image characteristics on the basis of the evaluation; and
accepting the subset of image characteristics as the set of image characteristics on the basis of the evaluation, thereby identifying the set of image characteristics.
